(19) United States
(12) Patent Application Publication
(10) Pub. No.: US 2026/0319394 A1
(43) Pub. Date: Oct. 15, 2026

(54) IMAGE FORMING APPARATUS WITH ROTARY INCLUDING A CONTAINER FOR CONTAINING DEVELOPING AGENT AND CONFIGURED TO ROTATE

(71) Applicant: CANON KABUSHIKI KAISHA, Tokyo (JP)

(72) Inventor: KEN OI, Tokyo (JP)

(21) Appl. No.: 19/632,841

(22) Filed: Mar. 30, 2026

(30) Foreign Application Priority Data
Apr. 9, 2025 (JP) 2025-064401

(51) Int. Cl. G03G 15/01; G03G 15/00

(52) U.S. Cl. CPC G03G 15/0173; G03G 15/556

(57) ABSTRACT

An image forming apparatus includes: a rotary that includes a first and second container including a first and second permanent magnet; a first sensor provided outside the rotary, a second sensor configured to sense the rotary; and at least one CPU. A minimum distance between the first permanent magnet and the first sensor is smaller than a minimum distance between the second permanent magnet and the first sensor at a first time point at which a first time has elapsed since the rotary is sensed by the second sensor. The at least one CPU is configured to: determine that an amount of developing agent in the first container is less than a first threshold, based on the signal at the first time point.

### BACKGROUND

### Field of the Technology

The present disclosure relates to an image forming apparatus.

### Description of the Related Art

US 2011-0206389 discloses an image forming apparatus that uses a plurality of developing units, in which the amount of developing agent in each of the developing units is detected. According to US 2011-0206389, a movable magnetic material is provided inside a container of each developing unit that contains a developing agent, and magnetism emitted by the magnetic material is detected by a reed sensor, so that the amount of developing agent is detected. In addition, according to US 2011-0206389, an eccentric cam rotated to swing the magnetic material, in order to prevent the magnetic material from being buried in the developing agent.

### SUMMARY

According to an aspect of the present disclosure, an image forming apparatus includes: a rotary that is configured to rotate and includes a first container configured to contain a first developing agent and a second container configured to contain a second developing agent; a first permanent magnet supported by the first container so as to be movable inside the first container; a second permanent magnet supported by the second container so as to be movable inside the second container; a first sensor provided outside the rotary, and configured to detect a magnetic field and output a signal; a second sensor configured to sense the rotary in a sensing orientation; and at least one CPU, wherein a time point at which the rotary in the sensing orientation is sensed by the second sensor is defined as a sensing time point, a time point at which a first time has elapsed since the sensing time point is defined as a first time point, and a time point at which a second time has elapsed since the sensing time point is defined as a second time point, wherein at the first time point, a minimum distance between the first permanent magnet and the first sensor is smaller than a minimum distance between the second permanent magnet and the first sensor, wherein at the second time point, the minimum distance between the second permanent magnet and the first sensor is smaller than the minimum distance between the first permanent magnet and the first sensor, and wherein the at least one CPU is configured to: determine that an amount of the first developing agent in the first container is less than a first threshold, based on the signal at the first time point; and determine that an amount of the second developing agent in the second container is less than a second threshold, based on the signal at the second time point.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional view of an image forming apparatus.

FIG. 2 is a diagram illustrating a developing unit and a cartridge.

FIG. 3 is a perspective view of a rotary.

FIG. 4 is a cross-sectional view of the rotary when the amounts of toner in the developing units are at the level of 100%.

FIG. 5 is a diagram showing a configuration of a magnetic material unit.

FIG. 6 is a cross-sectional view of the rotary when the amounts of toner in the developing units are at the level of 82%.

FIG. 7 is a cross-sectional view of the rotary when the amounts of toner in the developing units are at the level of 60%.

FIG. 8 is a diagram showing an example of the relationship between elapsed time and the magnetic flux density detected by a magnetic flux detection unit.

FIG. 9 is a diagram showing an example of a configuration for detecting the amount of toner.

FIG. 10 is a diagram showing an example of the relationship between the amount of toner in a developing unit and the maximum value of a magnetic flux detection signal output by the magnetic flux detection unit.

FIG. 11 is a diagram showing examples of variations over time in the magnetic flux detection signal and in a rotational phase detection signal.

FIG. 12 is a flowchart of toner amount determination processing.

FIG. 13 is a diagram showing other examples of variations over time in the magnetic flux detection signal and in the rotational phase detection signal.

FIG. 14 is another flowchart of the toner amount determination processing.

FIG. 15 is a diagram showing yet other examples of variations over time in the magnetic flux detection signal and in the rotational phase detection signal.

FIGS. 16A and 16B are diagrams each showing an example of a configuration for detecting the rotational phase of the rotary.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

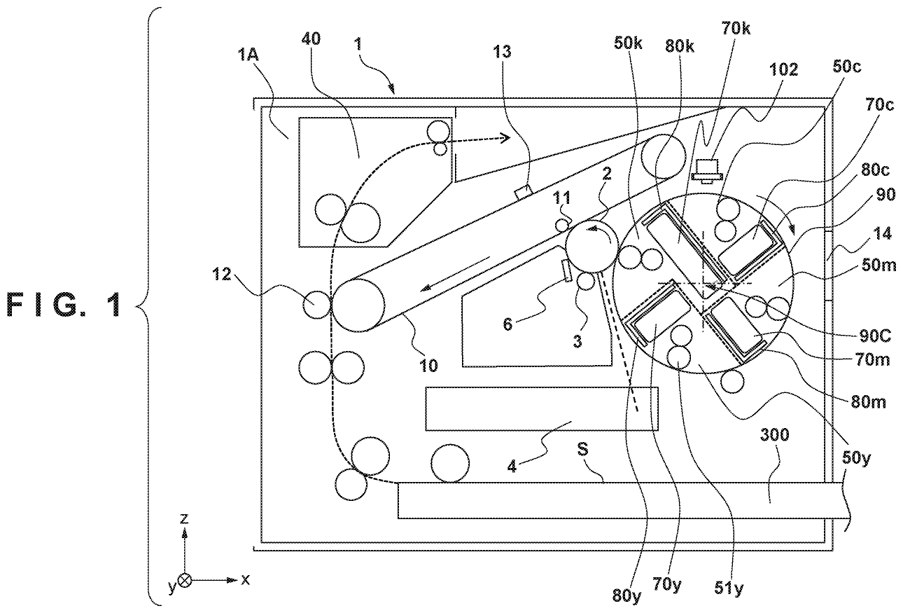

FIG. 1 shows an image forming apparatus 1 for use in description of the embodiment. In the following description, the vertical direction when the image forming apparatus 1 is installed on a horizontal surface is taken as the z direction. The direction of a rotation axis 90C of a rotary 90, which intersects the z direction, is taken as the y direction. The direction that intersects both the z direction and the y direction is taken as the x direction. The x direction and the y direction are preferably horizontal directions. The x direction, the y direction, and the z direction are preferably orthogonal to each other.

An apparatus main body 1A of the image forming apparatus 1 includes a drum-shaped photoconductor 2. A charging roller 3, a scanner 4 serving as an exposure device, a cleaning unit 6, the rotary 90, and an intermediate transfer belt 10 are disposed in the surroundings of the photoconductor 2. The rotary 90 houses developing units 50y, 50m, 50c and 50k. The rotary 90 also includes trays 80y, 80m, 80c and 80k, which serve as support members. The trays 80y, 80m, 80c and 80k are configured to hold respective cartridges 70y, 70m, 70c and 70k that contain toner serving as a developing agent. The cartridges 70y, 70m, 70c and 70k contain yellow, magenta, cyan, and black toner and supply the toner to the respective developing units 50y, 50m, 50c and 50k.

Note that the letters “y”, “m”, “c” and “k” at the end of the respective reference signs indicate that the color of the image formed by the member indicated by the corresponding reference sign is yellow, magenta, cyan, and black, respectively. In the following description, when there is no need to distinguish between the colors of the images formed by the members, the reference sign without any letter at the end thereof is used collectively.

During image formation, the photoconductor 2 is driven to rotate in the counter-clockwise direction shown in the figure. The charging roller 3 evenly charges the surface of the photoconductor 2. The scanner 4 forms an electrostatic latent image for a yellow image on the photoconductor 2 based on image data for a yellow image. In addition, in order to develop the electrostatic latent image for a yellow image formed on the photoconductor 2 with yellow toner, the rotary 90 is rotated in the clockwise direction shown in the figure so that a developing roller 51y of the developing unit 50y opposes the photoconductor 2. In the following description, the orientation of the rotary 90 in which the developing roller 51y opposes the photoconductor 2 is called a “yellow developing orientation”. Similar to the yellow developing orientation, a magenta developing orientation, a cyan developing orientation, and a black developing orientation are defined.

The electrostatic latent image for a yellow image formed on the photoconductor 2 is developed with yellow toner by the developing unit 50y, thereby forming a yellow image on the photoconductor 2. A primary transfer roller 11 transfers the yellow image formed on the photoconductor 2 to an intermediate transfer belt 10. Then, the rotary 90 is set to the magenta developing orientation to form a magenta image on the photoconductor 2. The primary transfer roller 11 transfers the magenta image formed on the photoconductor 2 so that it is superimposed on the yellow image on the intermediate transfer belt 10. Thereafter, similarly, a cyan image and a black image are sequentially transferred to the intermediate transfer belt 10. By transferring the black image to the intermediate transfer belt 10, an image that is to be transferred to a sheet S is formed on the intermediate transfer belt 10. Note that a secondary transfer roller 12 and a cleaning device 13 are separated from the intermediate transfer belt 10 until the images of the four colors are transferred to the intermediate transfer belt 10.

On the other hand, the sheet S held in a cassette 300 is conveyed along a conveyance path provided in the apparatus main body 1A. A plurality of conveyance rollers are provided along the conveyance path to convey the sheet S. The secondary transfer roller 12 transfers the image formed on the intermediate transfer belt 10 to the sheet S. A fixing device 40 heats and pressurizes the sheet S to fix the image on the sheet S. Then, the sheet S is ejected to the outside of the image forming apparatus 1. Note that, when forming a monochrome image on a sheet S, the rotary 90 is set to the black developing orientation to form a black image on the photoconductor 2, and the black image is transferred to the sheet S via the intermediate transfer belt 10.

The apparatus main body 1A has a door 14 for use in replacing the cartridge 70. When replacing the cartridge 70, the rotary 90 is rotated so that the tray 80 holding the cartridge 70 to be replaced opposes the door 14. Then, the tray 80 is slid toward the door 14, so as to protrude from the rotary 90. The door 14 is designed to open when pushed by the tray 80 and close when the tray 80 is housed inside the rotary 90. By moving the tray 80 to the outside of the apparatus main body 1A, the user can replace the cartridge 70. In other words, the cartridge 70 is configured to be removable with respect to the apparatus main body 1A. In addition, a magnetic flux detection unit 102 for detecting the remaining amount of toner within the developing unit 50 is provided in the apparatus main body 1A.

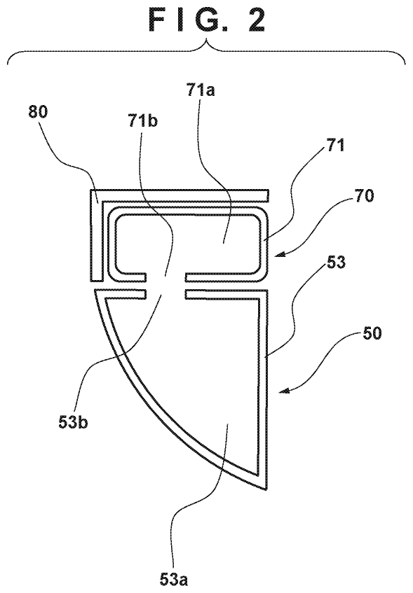

FIG. 2 is a diagram illustrating the developing unit 50 and the cartridge 70. The cartridge 70 has a toner frame 71. The toner frame 71 includes a toner container 71a that contains toner, and a discharge opening 71b that communicates with the toner container 71a. The developing unit 50 includes a developing frame 53. The developing frame 53 is a container member that contains toner and includes a developing container 53a and a receiving opening 53b that communicates with the developing container 53a. Other members, such as the developing roller 51, are provided inside the developing frame 53 of the developing unit 50, but the illustrations thereof are omitted from FIG. 2 to simplify the figure.

When the cartridge 70 is in the mounted position relative to the developing frame 53, the discharge opening 71b is opposite the receiving opening 53b. In other words, the toner container 71a of the cartridge 70 and the developing container 53a of the developing unit 50 communicate with each other via the discharge opening 71b and the receiving opening 53b. The developing unit 50 is replenished with toner from the cartridge 70 when at least part of the receiving opening 53b is positioned below at least part of the discharge opening 71b.

The cartridge 70 may include a sealing member (not shown) that covers the discharge opening 71b. The developing unit 50 may also include a sealing member (not shown) that covers the receiving opening 53b. The sealing member prevents toner from flowing out of the discharge opening 71b and the receiving opening 53b even when the cartridge 70 is not mounted to the developing unit 50.

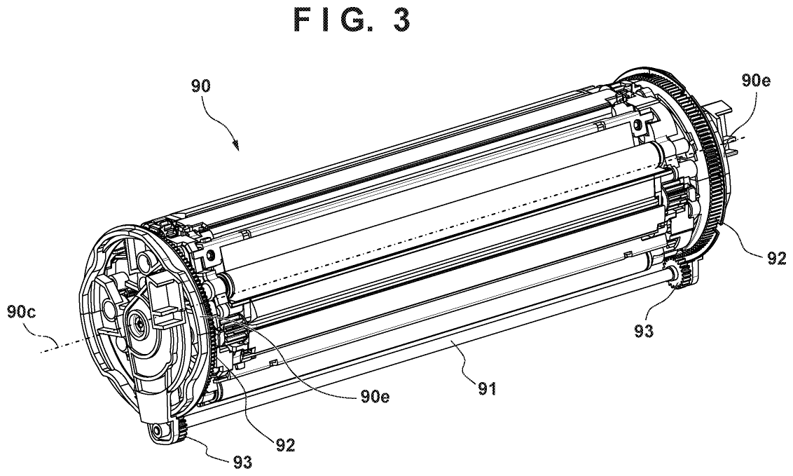

FIG. 3 is a perspective view of the rotary 90. Disc gears 92 are provided respectively at the two ends of the rotation axis 90C. Rotary drive gears 93 are respectively provided at the two ends of a swing shaft 91. A drive force of a motor (not shown) is transmitted to one of the rotary drive gears 93. The drive force is transmitted to the other rotary drive gear 93 via the swing shaft 91. The two rotary drive gears 93 also transfer the drive force to the respective disc gears 92. The rotary 90 rotates together with the disc gears 92.

The rotary 90 is supported so as to be swingable (e.g.., pivotable) about the swing shaft 91. The rotary 90 is biased about the swing shaft 91 by a biasing member (not shown) in a direction in which the developing roller 51 of the developing unit 50 in the developing orientation comes close to the photoconductor 2. As a result, the developing roller 51 in the developing orientation for each color comes into contact with the photoconductor 2. As shown in FIG. 3, rotary cams 90e are also provided respectively at the two ends of the rotary 90. The rotary cams 90e are configured to contact rollers (not shown) supported on the frame of the apparatus main body 1A. As a result, when the rotary 90 is rotated, the rotary 90 swings (e.g., about the swing shaft 91). With this swing, the developing roller 51 can be separated from the photoconductor 2.

The amount of toner contained in the developing unit 50 and the cartridge 70 decreases as a whole due to image formation. When the toner in the cartridge 70 runs low, it becomes difficult to supply the developing unit 50 with toner from the cartridge 70, resulting in a low toner level in the developing unit 50. When the toner level in the developing unit 50 is low, this may cause image defects. Accordingly, the image forming apparatus 1 is configured to be able to detect the amount of toner remaining in the developing unit 50. The low toner level in the developing unit 50 means that the amount of toner remaining in the cartridge 70 is low. Therefore, upon detecting that the toner level in the developing unit 50 is low, the image forming apparatus 1 warns the user to replace the cartridge 70.

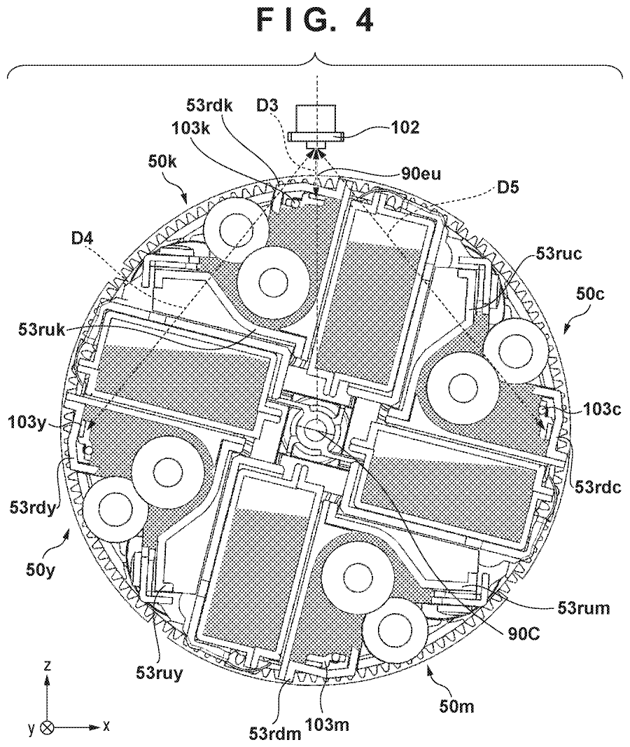

The following describes a configuration for detecting the amount of toner contained in the developing frame 53 of the developing unit 50. Note that, in the following description, the amount of toner contained in the developing frame 53 of the developing unit 50 is also referred to as the “amount of toner contained in the developing unit 50”. FIG. 4 is a cross-sectional view of the rotary 90. As previously described, the rotary 90 includes the developing units 50y, 50m, 50c and 50k. The developing units 50y, 50m, 50c and 50k include magnetic material units 103y, 103m, 103c and 103k, respectively.

The shaded regions in FIG. 4 indicate regions where toner is present. In FIG. 4, each developing unit 50 contains the maximum amount of toner that can be contained in the corresponding developing frame 53. In the following description, the amount of toner contained in the developing frame 53 is expressed as a percentage (%) relative to the maximum amount that can be contained in the developing frame 53. In other words, FIG. 4 shows a cross section of the rotary 90 when the amount of toner in each developing unit 50 is 100%.

In the following description, the direction of the rotation axis 90C of the rotary 90, i.e., the direction from the center of the rotary 90 toward the outer circumference of the rotary 90, is referred to as the radial direction. Also, in the following description, the member at the end of the developing frame 53 that is located on the downstream side in the radial direction is denoted as a downstream member 53rd, and the member at the end of the developing frame 53 that is located on the upstream side is denoted as an upstream member 53ru. In the radial direction, the distance between the upstream member 53ru and the rotation axis 90C is smaller than the distance between the downstream member 53rd and the rotation axis 90C. In addition, the downstream member 53rd and the upstream member 53ru are opposite each other in the radial direction. In addition, the downstream member 53rd and the upstream member 53ru extend in a direction that intersects the radial direction.

The magnetic flux detection unit 102 is positioned above the rotation axis 90C in the vertical direction. In the present embodiment, as shown in FIG. 4, the magnetic flux detection unit 102 is positioned above a rotary upper end 90eu, which is located at the uppermost position of the rotary 90 in the vertical direction. The magnetic flux detection unit 102 is located above the rotary 90 in the vertical direction and is arranged to oppose the rotary upper end 90eu. In other words, when viewed in the direction of the rotation axis 90C, the magnetic flux detection unit 102, the rotary upper end 90eu, and the rotation axis 90C are aligned in a straight line.

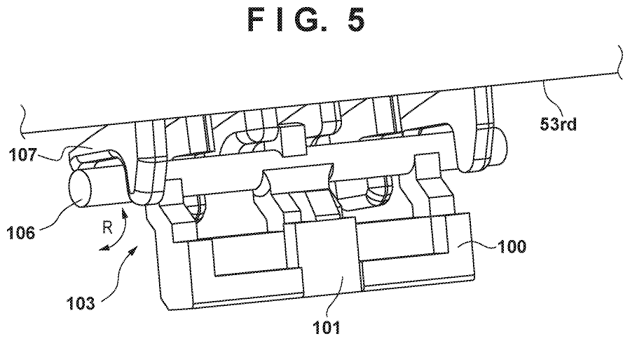

FIG. 5 is a perspective view of the magnetic material unit 103. The magnetic material unit 103 is attached to the downstream member 53rd of the developing frame 53. In more detail, a fixation member 107 of the magnetic material unit 103 is attached to the downstream member 53rd. The fixation member 107 supports the rotation shaft 106 so that it is rotatable in the R direction shown in FIG. 5. The axial direction of the rotation shaft 106 is, for example, parallel to the direction of the rotation axis 90C of the rotary 90. A support member 100 is attached to the rotation shaft 106 so as to rotate together with the rotation shaft 106. The support member 100 supports a permanent magnet 101, which is a magnetic material. Therefore, the permanent magnet 101 is supported by the downstream member 53rd so as to be turnable (e. g, rotatable) with the rotation shaft 106 serving as the center of rotation. The permanent magnet 101 is, for example, a neodymium magnet. The permanent magnet 101 has a first surface on the support member 100 side and a second surface opposite to the first surface. The first surface is either the N pole or the S pole (e.g., the north or south poles, respectively), and the second surface is the other of the N pole and the S pole. In the following explanation, the first surface is assumed to be the N pole and the second surface is assumed to be the S pole.

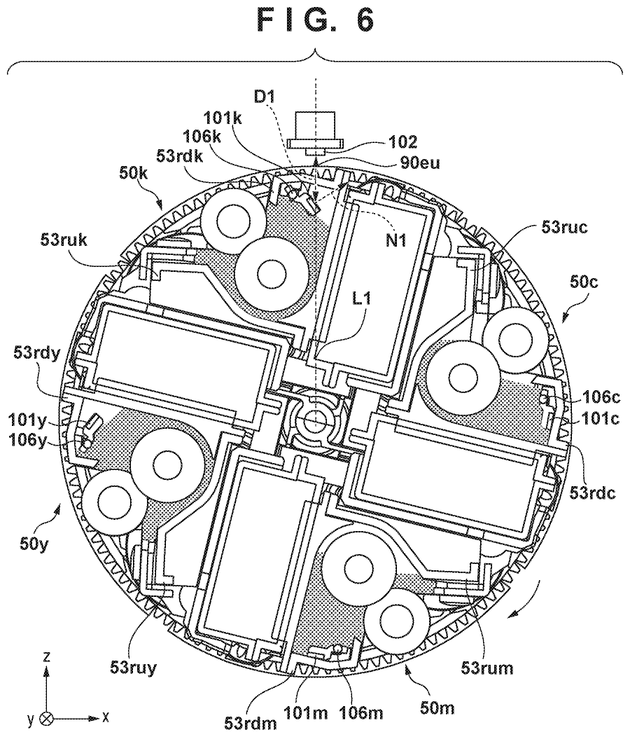

The change in orientation of the magnetic material unit 103 as the rotary 90 rotates is described with reference to FIG. 6. FIG. 6 shows a cross section of the rotary 90 when the amount of toner in each developing unit 50 is 82%. FIG. 6 is a diagram viewed in the direction of the rotation axis 90C. In the following description, the state where a certain developing unit 50 (e.g., one of the plurality of developing units 50) is located at the developing unit 50k shown in FIG. 6 is referred to as a first orientation of the developing unit 50. Also, the state where a certain developing unit 50 is located at the developing unit 50c shown in FIG. 6 is referred to as a second orientation of the developing unit 50. Furthermore, the state where a certain developing unit 50 is located at the developing unit 50m shown in FIG. 6 is referred to as a third orientation of the developing unit 50. Furthermore, the state where a certain developing unit 50 is located at the developing unit 50y shown in FIG. 6 is referred to as a fourth orientation of the developing unit 50. FIG. 6 shows the state where the developing unit 50k is in the first orientation, the developing unit 50c is in the second orientation, the developing unit 50m is in the third orientation, and the developing unit 50y is in the fourth orientation. The orientation of the developing unit 50 transitions cyclically in the order of the first orientation, the second orientation, the third orientation, and the fourth orientation, and back to the first orientation, due to the rotation of the rotary. In the following, when viewed in the direction of the rotation axis 90C, the straight line connecting the rotation axis 90C and the magnetic flux detection unit 102 is denoted as a straight line L1. In addition, the line segment connecting the rotation axis 90C and the magnetic flux detection unit 102 is denoted as a line segment L1.

In the developing unit 50 in the first orientation, the magnetic material unit 103 is located above the rotation axis 90C. Note that in the developing unit 50 in the first orientation, the rotation axis 90C, the permanent magnet 101, and the magnetic flux detection unit 102 are located on the straight line L1, when viewed in the direction of the rotation axis 90C. In the following description, when viewed in the direction of the rotation axis 90C, the timing at which the permanent magnet 101 of the developing unit 50 is located on the line segment connecting the rotation axis 90C and the magnetic flux detection unit 102 is referred to as a “parallel timing” of the developing unit 50.

When the developing unit 50 transitions from the first orientation to the second orientation by rotating the rotary 90 in the clockwise direction of the figure, the toner contained in the developing unit 50 moves from the upstream member 53ru side toward the downstream member 53rd due to gravity. The magnetic material unit 103 also rotates due to gravity so as to approach the downstream member 53rd. This rotation is regulated (e.g., affected) by the permanent magnet 101 and the support member 100 of the magnetic material unit 103 coming into contact with the downstream member 53rd.

When the developing unit 50 transitions from the second orientation to the third orientation by further rotating the rotary 90 in the clockwise direction of the figure, the toner contained in the developing unit 50 moves toward the downstream member 53rd. Note that since, in the second orientation, the rotation of the magnetic material unit 103 is regulated by the downstream member 53rd, the permanent magnet 101 and the support member 100 remain in contact with the downstream member 53rd in the third orientation.

When the developing unit 50 transitions from the third orientation to the fourth orientation by further rotating the rotary 90 in the clockwise direction of the figure, the toner contained in the developing unit 50 moves from the downstream member 53rd side toward the upstream member 53ru due to gravity. The magnetic material unit 103 also rotates due to gravity so as to approach the upstream member 53ru. This rotation is regulated by the permanent magnet 101 and the support member 100 of the magnetic material unit 103 coming into contact with the toner. Note that the position at which the rotation of the magnetic material unit 103 is regulated by the contact with the toner depends on the amount of toner in the developing unit 50.

When the developing unit 50 transitions from the fourth orientation to the first orientation by further rotating the rotary 90 in the clockwise direction of the figure, the toner contained in the developing unit 50 moves toward the upstream member 53ru due to gravity. The magnetic material unit 103 also rotates due to gravity so as to approach the upstream member 53ru, but this rotation is regulated by the permanent magnet 101 and the support member 100 of the magnetic material unit 103 coming into contact with the toner. Note that the position at which the rotation of the magnetic material unit 103 is regulated by the contact with the toner depends on the amount of toner in the developing unit 50.

In other words, at the parallel timing, the distance between the permanent magnet 101 and the magnetic flux detection unit 102 varies according to the amount of toner in the developing container 53a.

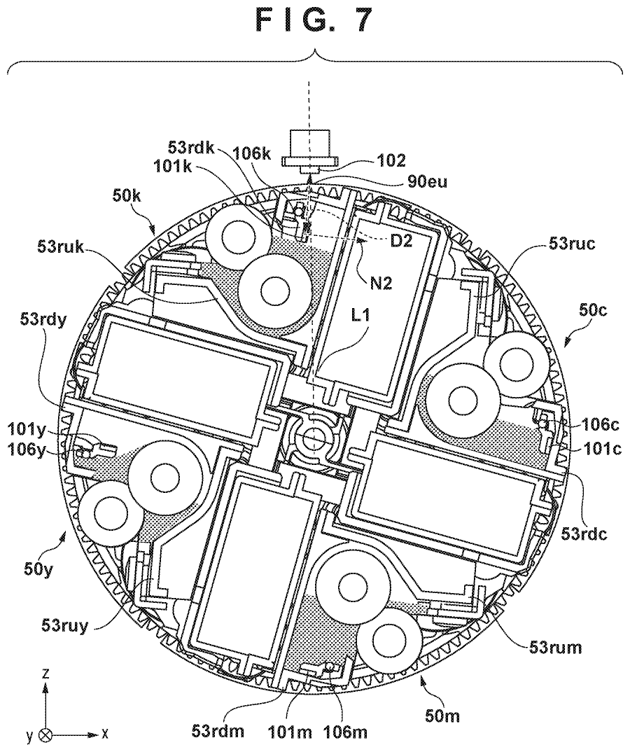

The following will describe the relationship between the amount of toner in the developing unit 50 and the magnetic flux density passing through the magnetic flux detection unit 102. FIG. 7 shows a cross section of the rotary 90 when the amount of toner in each developing unit is 60%. As shown in FIGS. 4, 6 and 7, the position of the permanent magnet 101 in the developing unit in the first orientation is closer to the downstream member 53rd as the amount of toner contained in the developing unit increases. In other words, the position of the permanent magnet 101 in the developing unit in the first orientation is closer to the magnetic flux detection unit 102 as the amount of contained toner increases. A straight line D1 in FIG. 6 shows the distance between the permanent magnet 101 and the magnetic flux detection unit 102 when the amount of toner in the developing unit is 82%. A straight line D2 in FIG. 7 shows the distance between the permanent magnet 101 and the magnetic flux detection unit 102 when the amount of toner in the developing unit is 60%. As is clear from the figures, the length of the straight line D1 is shorter than the length of the straight line D2.

Furthermore, the angle between the normal direction of the second surface of the permanent magnet 101 and the straight line L1 approaches zero as the amount of contained toner increases. An arrow N1 in FIG. 6 shows the normal direction of the second surface of the permanent magnet 101 when the amount of toner in the developing unit is 82%. An arrow N2 in FIG. 7 shows the normal direction of the second surface of the permanent magnet 101 when the amount of toner in the developing unit is 60%. As is clear from the figures, the angle between the direction of the arrow N1 and the straight line L1 (e.g., direction from the rotation axis 90C toward the magnetic flux detection unit 102) is less than the angle between the direction of the arrow N2 and the straight line L1.

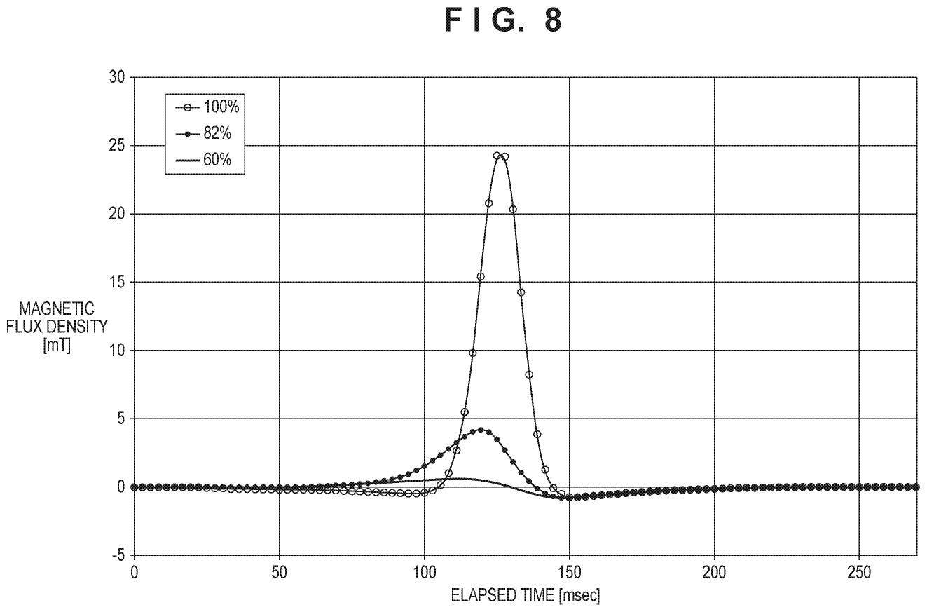

FIG. 8 shows an example of the variations over time in the magnetic flux density passing through the magnetic flux detection unit 102 when the rotary 90 is rotated at a speed of one revolution per second. The horizontal axis in FIG. 8 represents the time elapsed since the rotary 90 began to rotate. FIG. 8 shows the variations in magnetic flux density over the period of approximately 250 ms, that is, the period during which the rotary 90 makes approximately one quarter of a revolution. During the period during which the rotary 90 makes approximately one quarter of a revolution, one developing unit 50 passes through the position that is opposite the magnetic flux detection unit 102. In other words, the period shown in FIG. 8 includes the parallel timing of one developing unit 50. The vertical axis represents the magnetic flux density passing through the magnetic flux detection unit 102. In other words, the vertical axis represents the magnetic flux density detected by the magnetic flux detection unit 102. The magnetic flux density passing through the magnetic flux detection unit 102 varies depending on the orientation of the developing unit 50, and is maximum near the parallel timing of the developing unit 50. As shown in FIG. 8, the maximum magnetic flux density passing through the magnetic flux detection unit 102 is about 24 mT when the amount of toner is 100%, while it is about 1 mT when the amount of toner is 60%. In this way, the amount of toner contained in the developing unit 50 can be determined based on the magnetic flux density passing through the magnetic flux detection unit 102.

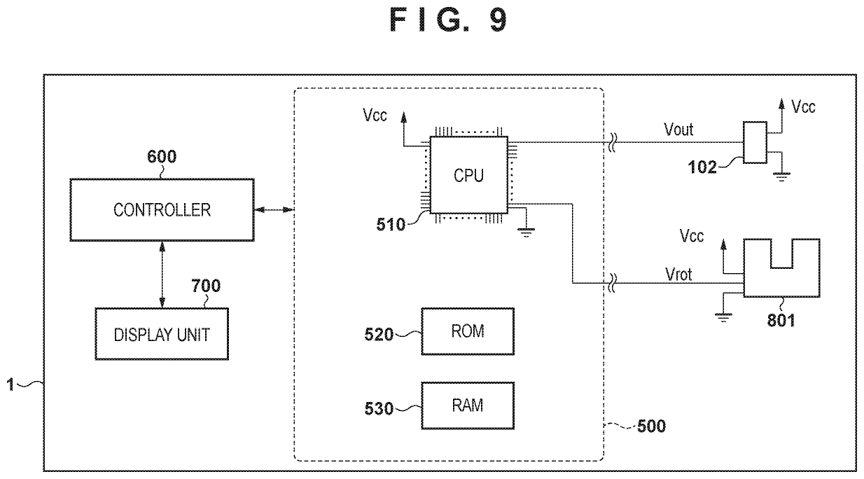

FIG. 9 shows an example of a configuration for measuring the amount of toner in the developing unit 50. In FIG. 9, Vcc refers to an operating voltage at a CPU 510, the magnetic flux detection unit 102, and a phase detection unit 801 supplied from a power supply (not shown), and is 3.3 V, for example. A controller 600 controls the entire image forming apparatus 1. A display unit 700 provides an input/output interface to the user. The controller 600 controls the formation of images onto a sheet S as described with reference to FIG. 1, for example, upon input of a print job from a host computer (not shown) via a network. In addition, the controller 600 controls, for example, the display of information by the display unit 700. The CPU 510 of an engine control unit 500 executes, for example, a control program stored in a ROM 520, which is an example of a non-volatile memory, to determine the amount of toner in the developing unit 50. That is, the CPU 510 serves as a toner amount determination unit. In the embodiment, there is one CPU 510, but the image forming apparatus 1 may have at least one additional CPU for determining the toner amount. The CPU 510 uses, as a work area, a RAM 530, which is an example of a volatile memory. The RAM 530 is a storage unit. The RAM 530 can also store information indicating the amount of toner in the developing unit 50 determined by the CPU 510, and the like.

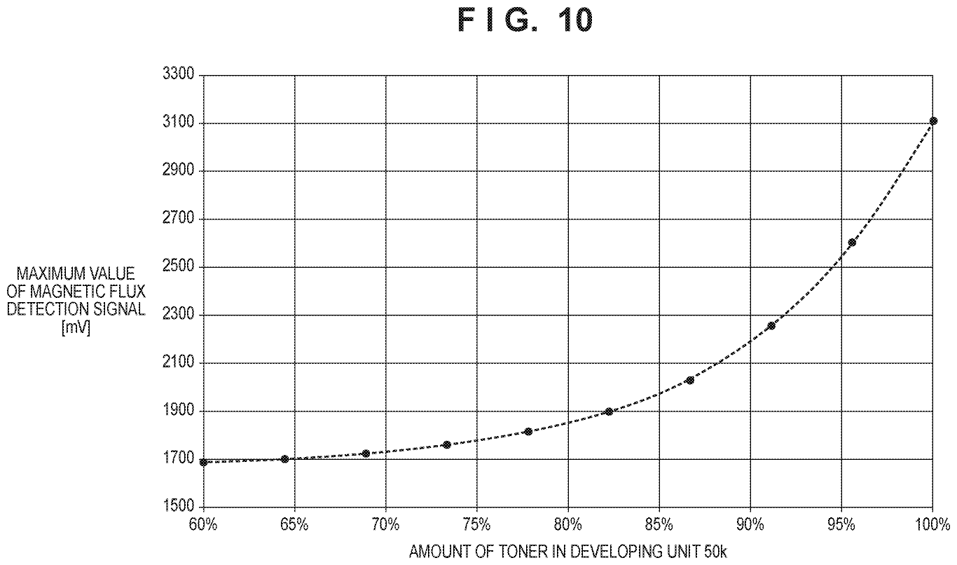

The magnetic flux detection unit 102 includes a sensor for detecting the magnetic field. The magnetic flux detection unit 102 includes a Hall IC sensor of a linear output type, for example. The magnetic flux detection unit 102 outputs, to the CPU 510, a magnetic flux detection signal Vout that indicates the detection result of the magnetic flux density passing in the vertical direction (such as the z direction in FIG. 7 and the like), for example. The value of Vout is proportional to the magnitude of the magnetic flux density detected by the magnetic flux detection unit 102, for example. FIG. 10 shows an example of the relationship between the amount of toner in the developing unit 50k and the maximum value (peak value) of the magnetic flux detection signal output by the magnetic flux detection unit 102. The CPU 510 stores the value of the magnetic flux detection signal Vout in the RAM 530. The information as shown in FIG. 10 that indicates an example of the relationship between the amount of toner in the developing unit 50 and the maximum value of the magnetic flux detection signal output by the magnetic flux detection unit 102 is generated in advance and stored, for example, in the ROM 520.

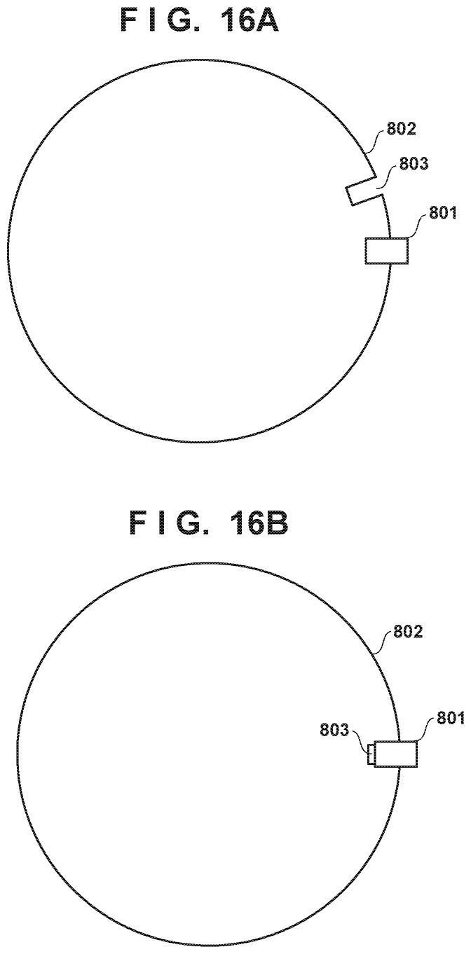

The phase detection unit 801 is provided to detect the rotational phase of the rotary 90. FIGS. 16A and 16B show examples of a configuration for detecting the rotational phase of the rotary 90. The phase detection unit 801 is, for example, a photo interrupter and has a light emitting element and a light receiving element. The light emitting element and the light receiving element of the phase detection unit 801 are located opposite each other with respect to a sensing target member 802. The sensing target member 802 is configured to rotate one revolution when the rotary 90 rotates one revolution via a transmission mechanism (not shown in FIG. 3 or the like). A notch 803 is provided in the outer periphery of the sensing target member. As shown in FIG. 16A, when the notch 803 is positioned between the light emitting element and the light receiving element of the phase detection unit 801, the light receiving element receives light emitted from the light emitting element. On the other hand, as shown in FIG. 16B, when the notch 803 is not positioned between the light emitting element and the light receiving element of the phase detection unit 801, the sensing target member 802 shields light from the light emitting element, so that the light receiving element does not receive the light from the light emitting element. Therefore, the CPU 510 can sense that the rotational phase of the rotary 90 is a predetermined phase, based on the timing at which the light receiving element receives light from the light emitting element. Note that in the examples shown in FIGS. 16A and 16B, the sensing target member 802 is configured to shield light from the light emitting element for most of the period during which the rotary 90 rotates one revolution. However, the period during which the sensing target member 802 shields light from the light emitting element and the period during which the sensing target member 802 does not shield the light can be set arbitrarily.

In the following explanation, the rotational phase of the rotary 90 at the timing at which the light receiving element transitions from a state of receiving light from the light emitting element to a state of not receiving light is denoted as a “reference phase”, and the orientation of the rotary 90 at that time is denoted as a “sensing orientation”. The phase detection unit 801 outputs, to the CPU 510, a rotational phase detection signal Vrot that indicates the sensing result for the sensing target member 802, more precisely, the light sensing results by the light receiving element. The rotational phase detection signal Vrot is also a signal indicating the time point (sensing time point) when the rotary 90 is in the sensing orientation. For example, upon receiving light, the light receiving element of the phase detection unit 801 sets the rotational phase detection signal Vrot to a high level (Hi), and otherwise, sets the rotational phase detection signal Vrot to a low level (Lo). In the present embodiment, the sensing target member 802 is mounted such that, when the rotary 90 is rotated by an angle θ in the clockwise direction of FIG. 7 after the rotational phase detection signal Vrot has been switched from the high level to the low level, the value of the magnetic flux density of the permanent magnet 101 of the developing unit 50k containing the toner at the level of 100% measured by the magnetic flux detection unit 102 is the maximum. The angle θ can be 45 degrees, for example. In other words, when the rotary in the sensing orientation is rotated by about 45 degrees, the magnetic flux detection unit 102 can maximally detect the magnetic flux density of the permanent magnet 101 in the developing unit 50k.

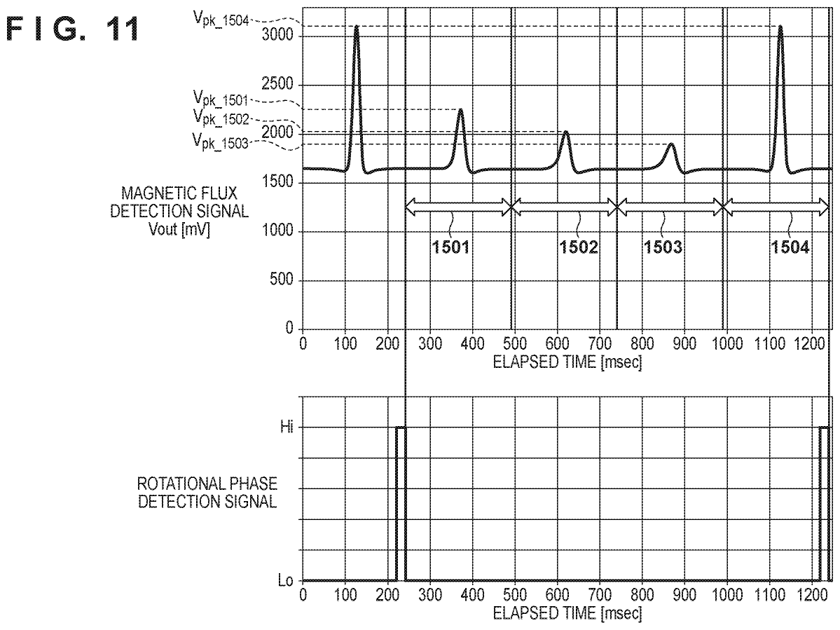

FIG. 11 shows variations over time in the magnetic flux detection signal Vout and the rotational phase detection signal Vrot when the rotary 90 is rotated at a rotational speed of 1 revolution/second (hereafter, 1 rps). The sensing target member 802 is configured such that, when the rotary 90 is rotated at 1 rps, the rotation phase detection signal Vrot raises to a high level for an interval approximately 20 ms during each revolution. The toner amount detection period is determined for each developing unit 50, based on the timing at which the rotational phase detection signal Vrot has changed from a high level to a low level. Period determination information indicating the start and end timings of each detection period from the timing at which the rotational phase detection signal Vrot changes from a high level to a low level is stored in advance in the ROM 520. A detection period 1501 shown in FIG. 11 is the detection period for the developing unit 50k, a detection period 1502 is the detection period for the developing unit 50y, a detection period 1503 is the detection period for the developing unit 50m, and a detection period 1504 is the detection period for the developing unit 50c. The detection period that corresponds to the developing unit 50 includes the parallel timing of the developing unit 50. Note that in the present embodiment, the lengths of the detection periods 1501 to 1504 are each 250 ms. In other words, in the present embodiment, the sum of the detection periods 1501 to 1504 is equal to the time required for the rotary 90 to rotate one revolution. In other words, each of the detection periods 1501 to 1504 is equal to the period during which the rotary 90 rotates 90 degrees.

As shown as Vpk_1501 to Vpk_1504 in FIG. 11, the magnetic flux detection signal Vout of the magnetic flux detection unit 102 can peak near the parallel timing of each developing unit 50.

FIG. 4 shows the case where the developing unit 50k is in the first orientation, and the developing unit 50y is in the fourth orientation. The state in FIG. 4 corresponds to the detection period 1501. At this time, a minimum distance D3 between the magnetic flux detection unit 102 and the permanent magnet 101 of the developing unit 50k is less than a minimum distance D4 between the magnetic flux detection unit 102 and the permanent magnet 101 of the developing unit 50y. Then, in the detection period 1502, the developing unit 50k is in the second orientation, and the developing unit 50y is in the first orientation. Therefore, the state where the developing unit 50k in FIG. 4 is replaced with the developing unit 50y and the developing unit 50c in FIG. 4 is replaced with the developing unit 50k corresponds to the detection period 1502. At this time, a minimum distance D3 between the magnetic flux detection unit 102 and the permanent magnet 101 of the developing unit 50y is less than a minimum distance D5 between the magnetic flux detection unit 102 and the permanent magnet 101 of the developing unit 50k.

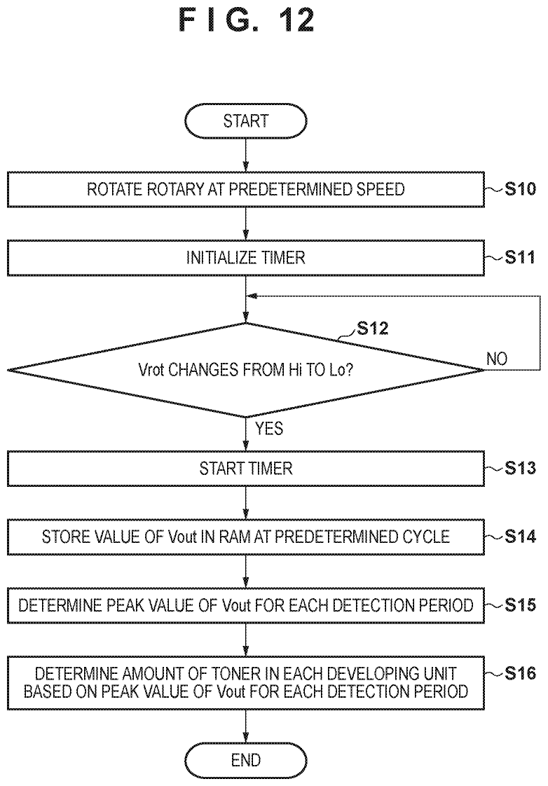

FIG. 12 is a flowchart of the determination processing that the CPU 510 performs to determine the amount of toner in each developing unit 50. In S10, the CPU 510 rotates the rotary 90 at a predetermined rotational speed, for example, 1 rps. In S11, the CPU 510 initializes a timer to, for example, 0. In S12, the CPU 510 stands by until the rotational phase detection signal Vrot falls from a high level to a low level.

When the rotational phase detection signal Vrot falls from a high level to a low level, the CPU 510 starts counting the elapsed time using a timer, in S13. Thereafter, in S14, the CPU 510 stores the value of the magnetic flux detection signal Vout in the RAM 530 in association with the timer value (e.g., count value) of the timer, at a predetermined cycle. The predetermined cycle can be, for example, 1 ms. The processing in S14 is performed from the timing at which the rotational phase detection signal Vrot falls from a high level to a low level, until the rotary 90 is rotated by one revolution. Note that a configuration is also possible in which the value of the magnetic flux detection signal Vout is stored in the RAM 530 in association with period information indicating the detection period, instead of the timer value.

In S15, the CPU 510 determines to which of the detection periods 1501 to 1504 the value of the magnetic flux detection signal Vout stored in the RAM 530 belongs, based on the timer value recorded in the RAM 530. For example, the value of the magnetic flux detection signal Vout associated with a timer value between 1 ms and 250 ms belongs to the detection period 1501, and the value of the magnetic flux detection signal Vout associated with a timer value between 251 ms and 500 ms belongs to the detection period 1502. Similarly, the value of the magnetic flux detection signal Vout associated with a timer value between 501 ms and 750 ms belongs to the detection period 1503, and the value of the magnetic flux detection signal Vout associated with a timer value between 751 ms and 1000 ms belongs to the detection period 1504. Note that when the value of the magnetic flux detection signal Vout stored in the RAM 530 is associated with period information, the CPU 510 determines the detection period to which each magnetic flux detection signal Vout belongs, based on the period information. The CPU 510 determines the peak (maximum) value of the magnetic flux detection signal Vout for each of the detection periods 1501 to 1504. In S16, the CPU 510 determines the amount of toner in each developing unit 50 based on the peak value of each of the detection periods 1501 to 1504, and stores the determined value in the RAM 530. To determine the amount of toner, the information stored in the ROM 520 indicating the relationship between the peak value and the amount of toner in each developing unit 50, that is, the information shown in FIG. 10 or the like is used. The controller 600 can cause, for example, the display unit 700 to display information indicating the amount of toner in each developing unit 50 stored in the RAM 530. The controller 600 can compare the amount of toner in each developing unit 50 stored in the RAM 530 with a threshold to determine whether the amount of toner in each developing unit 50 is less than the threshold. If the amount of toner in the developing unit 50 is less than the threshold, the controller 600 can determine that the cartridge 70 that supplies toner to this developing unit 50 needs to be replaced. In this case, the controller 600 can cause the display unit 700 to display information indicating that the cartridge 70 needs to be replaced. In addition, the display unit 700 may display not only toner amount information, but also information relating to the toner amount determination result. Note that the threshold for use in comparison with the toner amount may be the same or different for each developing unit 50.

Note that, in the present embodiment, each detection period is specified by counting the time elapsed using the timer since the rotational phase detection signal Vrot has switched from a high level to a low level. However, each detection period may be specified, instead of using the timer, based on the rotation amount of a motor for driving the rotary 90.

Although the toner amount is determined based on the peak value of the magnetic flux detection signal Vout in each detection period, a configuration is also possible in which the toner amount is determined based on the value calculated from all or some of the plurality the magnetic flux detection signals Vout values in a detection period, such as the integral value of the magnetic flux detection signals Vout values in the detection period.

In the present embodiment, the Hall IC sensor of a linear output type is used as the magnetic flux detection unit 102, but a sensor of a switch output type that inverts its output when the magnetic flux density is a predetermined threshold or more can also be used as the magnetic flux detection unit 102. If a sensor of a switch output type is used (e.g., a Hall IC sensor of a switch output type), the amount of toner in the developing unit 50 can be determined based on the period during which the output is inverted.

In the present embodiment, the frequency at which the rotational phase detection signal Vrot switches from a high level to a low level is once per revolution of the rotary 90. In other words, in the present embodiment, the phase detection unit 801 functions to detect one rotational phase (one reference phase) of the rotary 90. However, the phase detection unit 801 may also be configured to detect a plurality of rotational phases of the rotary 90. Furthermore, in the present embodiment, the amounts of toner in the developing units 50 are determined in order by rotating the rotary 90 one revolution, but a configuration is also possible in which the amount of toner in only one developing unit 50 is determined. For example, a configuration is possible in which, when a certain developing unit 50 transitions to the developing orientation, only the amount of toner in that developing unit 50 is determined.

Accordingly, by determining the detection periods 1501 to 1504 for the amounts of toner in the developing units 50 based on the result of sensing of the sensing target member 802 by the phase detection unit 801, the amount of toner in each developing unit 50 can be determined with accuracy.

### Second Embodiment

Next, a second embodiment will be described, focusing on the differences from the first embodiment. For example, in the first embodiment, the value of the magnetic flux detection signal Vout is stored in the RAM 530 every 1 ms. Therefore, it is necessary to ensure a storage area for storing 1000 Vout values in the RAM 530. On the other hand, as shown in FIG. 11, in each of the detection periods 1501 to 1504, the period during which the magnetic flux from the permanent magnet 101 passes through the magnetic flux detection unit 102 and this changes the value of the magnetic flux detection signal Vout is limited.

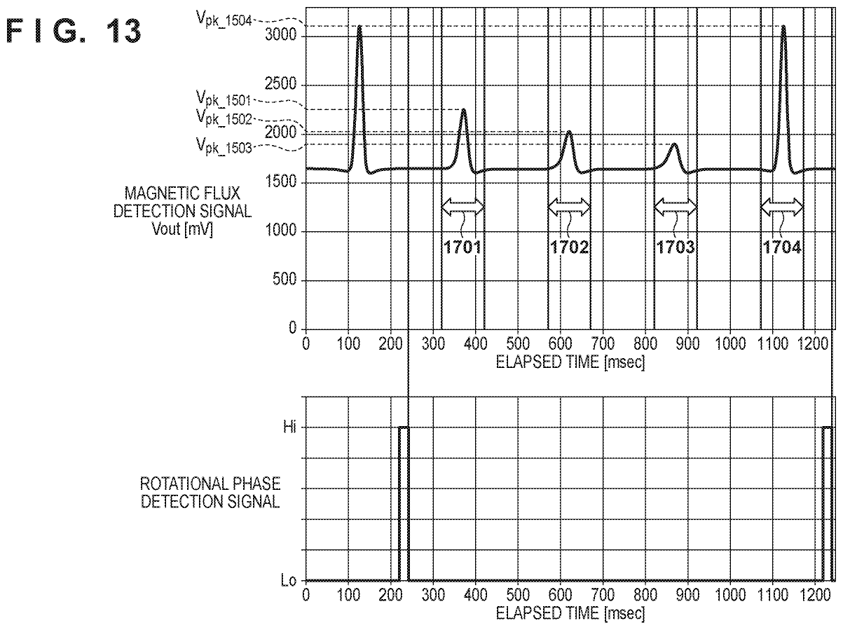

Therefore, in the present embodiment, as shown in FIG. 13, the detection period for each developing unit 50 is shorter than that in the first embodiment. A detection period 1701 for the developing unit 50k is, for example, the period from 81 ms to 180 ms. A detection period 1702 for the developing unit 50y is, for example, the period from 331 ms to 430 ms. A detection period 1703 for the developing unit 50m is, for example, the period from 581 ms to 680 ms. A detection period 1704 for the developing unit 50c is, for example, the period from 831 ms to 930 ms. Note that the above-described time is measured on the assumption that the timing when the rotational phase detection signal Vrot is changed from a high level to a low level is 0 ms. In this way, in the present embodiment, the sum of the detection periods 1701 to 1704 is less than the time of one revolution of the rotary 90. In other words, the detection periods 1701 to 1704 are each shorter than the time it takes for the rotary 90 to rotate 90 degrees. By limiting the period during which the value of the magnetic flux detection signal Vout is stored in the RAM 530 in this way, it is possible to reduce the capacity of the RAM 530 that must be secured to store the Vout value.

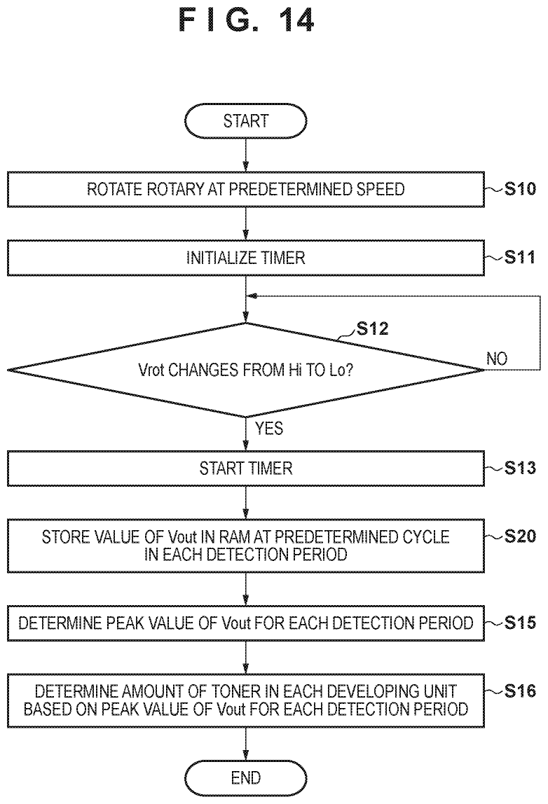

FIG. 14 is a flowchart of the determination processing that the CPU 510 performs to determine the amount of toner in each developing unit 50. Note that the same step numbers are given to the processing steps similar to those in the flowchart of the first embodiment shown in FIG. 12, and the descriptions of those steps are omitted. In the present embodiment, upon start of counting using the timer in S13, the CPU 510 repeatedly stores, in S20, the value of the magnetic flux detection signal Vout in the RAM 530 in association with the timer value for each of the detection periods 1701 to 1704 at predetermined intervals. In the present embodiment, the value of the magnetic flux detection signal Vout is not stored in the RAM 530 for a period that is not a detection period. The detection periods 1701 to 1704 are determined to include the parallel timing of each developing unit 50, taking into account various margins. The detection periods 1701 to 1704 are each determined based on the timing at which the rotational phase detection signal Vrot is switched from a high level to a low level.

As described above, in the present embodiment, the area in the RAM 530 required to store Vout values can be reduced compared to that in the first embodiment. In addition, by shortening the detection period used to determine the toner amount, the effect of disturbance occurring outside of the detection period can also be excluded.

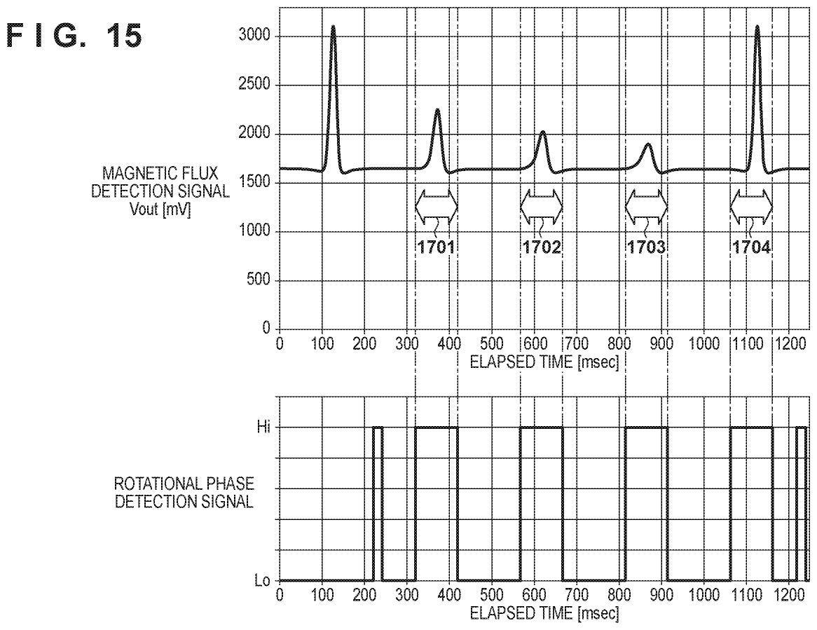

Note that in the present embodiment, the detection periods 1701 to 1704 have the same length, but the detection periods 1701 to 1704 may have different lengths. In addition, as shown in FIG. 15, the phase detection unit 801 and the sensing target member 802 may be configured to output high level as the rotational phase detection signal Vrot during each of the detection periods 1701 to 1704. In other words, the phase detection unit 801 and the sensing target member 802 are configured so that the rotational phases corresponding to the start timing and the end timing of each of the detection periods 1701 to 1704 can be detected, and the CPU 510 is notified of the detection of these rotational phases with the rotational phase detection signal Vrot. In this case, the CPU 510 can determine the start timing and the end timing of each detection period based on the rotational phase detection signal Vrot.

Note that in FIG. 15, the phase detection unit 801 detects the rotational phases of the rotary 90 at the start timing and end timing of each detection period, but a configuration is possible in which the rotational phase of the rotary 90 is detected at a timing prior to the start timing or end timing of each detection period by a predetermined period. In this case, the CPU 510 determines that the timing after the predetermined period from the timing notified by the phase detection unit 801 is the start timing or end timing of the detection period. In addition, in FIG. 15, for one detection period, two rotational phases (e.g., a rotational phase associated with the start timing and a rotational phase associated with the end timing) are detected, but a configuration is also possible in which the start timing and the end timing of one detection period are determined based on one rotational phase associated with the one detection period. Furthermore, a configuration is also possible in which the start timings and the end timings of two detection periods are determined based on one rotational phase associated with the two detection periods. In other words, a detection period is arbitrarily decided for which the start timing or end timing is to be determined based on a detected rotational phase.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-064401, filed Apr. 9, 2025, which is hereby incorporated by reference herein in its entirety.

What is claimed is:

1. An image forming apparatus comprising:
a rotary that is configured to rotate and includes a first container configured to contain a first developing agent and a second container configured to contain a second developing agent;
a first permanent magnet supported by the first container so as to be movable inside the first container;
a second permanent magnet supported by the second container so as to be movable inside the second container;
a first sensor provided outside the rotary, and configured to detect a magnetic field and output a signal;
a second sensor configured to sense the rotary in a sensing orientation; and
at least one CPU,
wherein a time point at which the rotary in the sensing orientation is sensed by the second sensor is defined as a sensing time point, a time point at which a first time has elapsed since the sensing time point is defined as a first time point, and a time point at which a second time has elapsed since the sensing time point is defined as a second time point,
wherein at the first time point, a minimum distance between the first permanent magnet and the first sensor is smaller than a minimum distance between the second permanent magnet and the first sensor,
wherein at the second time point, the minimum distance between the second permanent magnet and the first sensor is smaller than the minimum distance between the first permanent magnet and the first sensor, and
wherein the at least one CPU is configured to:
determine that an amount of the first developing agent in the first container is less than a first threshold, based on the signal at the first time point; and
determine that an amount of the second developing agent in the second container is less than a second threshold, based on the signal at the second time point.

2. The image forming apparatus according to claim 1, wherein
the first sensor outputs the signal during a first period including the first time point,
the first sensor outputs the signal during a second period that is after the first period and includes the second time point, and
the at least one CPU is further configured to determine a timing of the first period and a timing of the second period, based on a timing at which the second sensor has sensed the rotary in the sensing orientation.

3. The image forming apparatus according to claim 2, wherein the first period and the second period are both shorter than a time it takes for the rotary to rotate 90 degrees.

4. The image forming apparatus according to claim 1, wherein the at least one CPU is further configured to determine a timing of the first time point and a timing of the second time point by counting a given time after the sensing time point.

5. The image forming apparatus according to claim 1, wherein the at least one CPU is further configured to determine a timing of the first time point and a timing of the second time point based on information relating to an amount of rotation of the rotary after the sensing time point.

6. The image forming apparatus according to claim 2, wherein
when a timing at which the first permanent magnet is located on a line segment connecting a rotation axis of the rotary and the first sensor when viewed in a direction of the rotation axis is defined as a first parallel timing, and a timing at which the second permanent magnet is located on the line segment connecting the rotation axis of the rotary and the first sensor when viewed in the direction of the rotation axis is defined as a second parallel timing,
the first period includes the first parallel timing, and
the second period includes the second parallel timing.

7. The image forming apparatus according to claim 2, further comprising a storage unit configured to store information, wherein the storage unit does not store information based on the signal output by the first sensor between the first period and the second period.

8. The image forming apparatus according to claim 1, wherein the rotary includes a sensing target unit, and the second sensor is configured to sense the sensing target unit of the rotary in the sensing orientation.

9. The image forming apparatus according to claim 1, wherein a color of the first developing agent and a color of the second developing agent are different from each other.

10. The image forming apparatus according to claim 1, wherein the first sensor is located above a rotation axis of the rotary in a vertical direction.
